(19) United States
(12) Patent Application Publication
(10) Pub. No.: US 2006/0132422 A1
(43) Pub. Date: Jun. 22, 2006

(54) Method of driving liquid crystal display and liquid crystal display

(75) Inventors: Tomoya Teragaki, Kumamoto (JP); Kunifumi Nakanishi, Tokyo (JP); Akihiro Minami, Kumamoto (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: MITSUBISHI DENKI KABUSHIKI KAISHA, Tokyo (JP)

(21) Appl. No.: 11/253,590

(22) Filed: Oct. 20, 2005

(30) Foreign Application Priority Data
Dec. 20, 2004 (JP) 2004-368083

(51) Int. Cl. G09G 3/36

(52) U.S. Cl. 345/100

(57) ABSTRACT

In a 2H reverse driving method or the like as a driving method for a liquid crystal display, it is set that a time period from the time when the polarity of a data signal is reversed to the time when a gate selection signal is turned off should be equal to a period while a gate selection signal is in an ON period, and a period from the time when the gate selection signal is turned off to the time when the data signal is changed to a data output corresponding to a pixel selected by the gate selection signal is set equal to or shorter than a period from the time when the gate selection signal is turned off to the time when the polarity of the data signal is reversed.

### BACKGROUND OF THE INVENTION

1. Field of the Invention

The present invention relates to a selection signal for controlling conduction of a plurality of switching devices connected to a plurality of pixel electrodes, respectively, in a liquid crystal display, a driving method for controlling supply of data signals to a plurality of pixels through these switching devices, and a liquid crystal display provided with a control circuit for performing a control by the driving method.

2. Description of the Background Art

In a liquid crystal display, wire resistances of gate wires and stray capacitances of the wires cause dullness in a gate selection signal outputted from a gate driver to a gate wire and delay in the selection signal. As countermeasures against the above well known is a driving method for setting the time when the gate selection signal is changed from ON to OFF (hereinafter, referred to as “turn-off”) and the time when the signal is changed from OFF to ON (hereinafter, referred to as “turn-on”) earlier than the time when the polarity of data signal outputted from a source driver to a source wire is reversed by the delay time of the gate selection signal or more (e.g., Japanese Patent Application Laid Open Gazette No. 5-35215 (p. 1, FIG. 2: Patent Document 1).

On the other hand, as a 2 horizontal periods (hereinafter, the horizontal period is referred to as “H”) reverse driving method which is widely used as a method for preventing flickers and lowering power consumption in display of a dot-checkered image, by supplying data signals of the same polarity every 2H, well known are some driving methods for suppressing a lateral stripe moire for each line in display of full screen of halftone (hereinafter, referred to as “raster screen”).

Among the above well-known driving methods are, for example, a driving method in which the width of the gate selection signal which is generally a 1H period is reduced by a predetermined extent to ensure a horizontal blanking period and a selection period for a gate selection signal is thereby so set as to be sufficiently included in a corresponding data signal period (Japanese Patent Application Laid Open Gazette No. 2001-215469 (p. 4, FIG. 3: Patent Document 2), and a driving method in which a driving voltage output of the source driver in a horizontal blanking period between a gate selection signal of a line and that of the next line is reset and the output is once kept at an intermediate potential of the positive polarity and the negative polarity, and the difference in rising waveform between the data signal whose driving polarity is reversed between the positive polarity and the negative polarity and that whose driving polarity is not reversed is thereby minimized, to suppress the lateral stripe moire (Japanese Patent Application Laid Open Gazette No. 2004-61590 (pp. 3 to 4, FIGS. 2 and 7 to 9: Patent Document 3).

In the conventional 2H reverse driving methods for a liquid crystal display, the lateral stripe moire can be suppressed but a writing period to pixel electrodes in a 1H period disadvantageously becomes shorter.

In a case of liquid crystal display, generally, the frequency of vertical synchronization (frame frequency) is 60 Hz as a standard in consideration of power consumption and the visibility of flickers, and especially in a case of high-resolution liquid crystal display, the horizontal period becomes shorter as the number of lines in one screen increases. Therefore, especially in the case of high-resolution liquid crystal display, the charging time to pixels becomes shorter. In such a high-resolution liquid crystal display, if the conventional driving methods are adopted, the charge writing time to the pixel electrodes, i.e., the charging time can not be sufficiently ensured, and in driving a liquid crystal panel adopting a normally white liquid crystal mode, there arises a problem of causing luminance increase in display of full black screen to reduce contrast.

### SUMMARY OF THE INVENTION

It is an object of the present invention to provide a method of driving a liquid crystal display to achieve high contrast characteristics, by suppressing a lateral stripe moire in display of raster screen and ensuring a sufficient writing period to pixel electrodes, and to provide the liquid crystal display.

A method of driving a liquid crystal display in accordance with the present invention is a method by which a plurality of switching devices connected to a plurality of pixel electrodes surrounded by a plurality of gate wires and a plurality of source wires are controlled on conduction by a selection signal supplied through the gate wires, and through the switching devices, a data signal supplied through the source wires is supplied to the pixel electrodes. In the method of driving a liquid crystal display of the present invention, it is controlled that the polarity of the data signal is reversed in an ON period of a first gate selection signal and the polarity of the data signal is not reversed in an ON period of a second gate selection signal, a first period from the time when the polarity of the data signal is reversed to the time when the first gate selection signal is turned off is equal to a second period from the time when the second gate selection signal is turned on to the time when the second gate selection signal is turned off, and a fourth period from the time when the first gate selection signal is turned off to the time when the data signal is applied as data output corresponding to one of the pixel electrodes which is selected by the second gate selection signal is not longer than a third period from the time when the second gate selection signal is turned off to the time when the polarity of the data signal is reversed.

The method of driving a liquid crystal display in accordance with the present invention produces an effect of ensuring a sufficient charging time to each of the pixel electrodes and suppressing a lateral stripe moire for each line in display of raster screen.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing a liquid crystal display in accordance with first and second preferred embodiments of the present invention;

FIG. 2 is a driving timing chart of the liquid crystal display in accordance with the first preferred embodiment of the present invention; and

FIG. 3 is a driving timing chart of the liquid crystal display in accordance with the second preferred embodiment of the present invention.

### DESCRIPTION OF THE PREFERRED EMBODIMENTS

### The First Preferred Embodiment

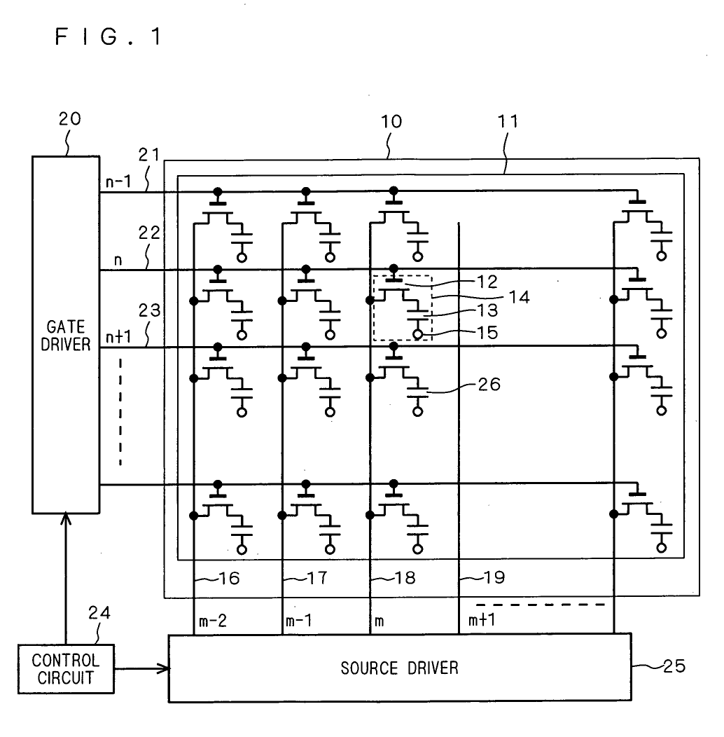

FIG. 1 is a diagram showing a liquid crystal display controlled by a driving method in accordance with the first preferred embodiment of the present invention. In FIG. 1, a normally white liquid crystal panel 10 has a structure in which an active matrix substrate 11 having a matrix arrangement consisting of a plurality of source wires (source interconnection lines) 16, 17, 18 and 19 and a plurality of gate wires (gate interconnection lines) 21, 22 and 23 which intersect each other and a not-shown opposed substrate which is opposite to the substrate 11 are bonded with a gap therebetween and in the gap, a not-shown liquid crystal is held. A pixel portion 14 indicated by broken line is placed at the intersection of the source wires 18 and 19 and the gate wires 22 and 23 and has a TFT 12 and a pixel electrode 13 as a switching device, and the gate wire 22, the source wire 18 and the pixel electrode 13 are connected to a gate, a source and a drain of the TFT 12, respectively. The pixel electrode 13 holds a liquid crystal with a counter electrode 15 which is an electrode of the opposed substrate, to form a capacitance, and when a gate selection signal applied to the gate wire 22 is turned on, the TFT 12 is turned on and the potential of the source wire 18 is written into the pixel electrode 13, and after the 1H period passes, the gate selection signal is turned off and the written potential is kept for one frame period or more. Further, a gate driver 20 is connected to end portions of the gate wires 21, 22 and 23 of the liquid crystal panel 10 and a source driver 25 is connected to end portions of the source wires 16, 17, 18 and 19, and these are controlled by a control circuit 24.

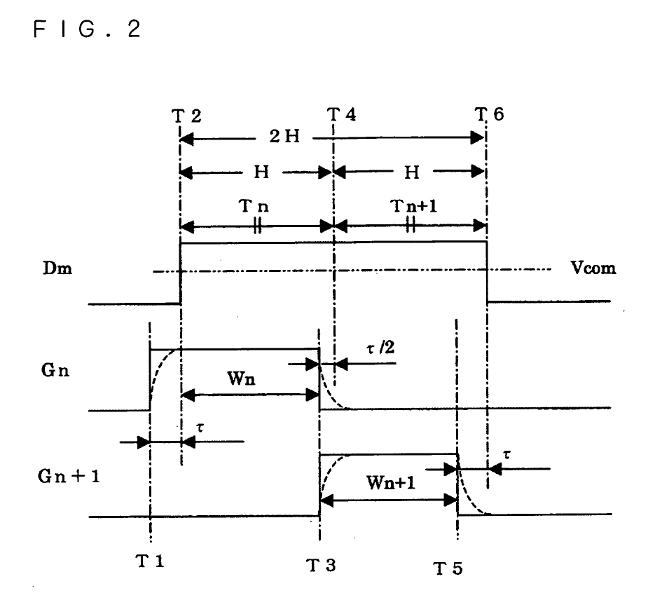

FIG. 2 is a timing chart showing a driving method for the liquid crystal display of FIG. 1 in accordance with the first preferred embodiment of the present invention. In displaying a raster screen on the normally white liquid crystal panel 10, a data signal Dm of FIG. 2 is supplied to the source wires 16, 17, 18 and 19 and written into the respective pixel electrodes 13 in one frame. The data signal Dm forms a rectangular wave consisting of a positive polarity in the upper portion of FIG. 2 and a negative polarity in the lower portion of FIG. 2 with the potential Vcom of the counter electrode 15 as the center of the positive and negative polarities, and as its amplitude becomes smaller, a brighter screen is displayed and as it becomes larger, a darker screen is displayed. Since the 2H reverse driving method is adopted in the first preferred embodiment, the data signal Dm is reversed from the negative polarity to the positive polarity at the time T2 and from the positive polarity to the negative polarity at the time T6 to alternate a driving voltage of the liquid crystal, and the interval is twice the horizontal period H.

Assuming that the central point of the period T2-T6 is the time T4, the period T2-T4 is a 1H period immediately after the polarity of the driving voltage of the data signal Dm is reversed with respect to the preceding not-shown 1H period and the period T4-T6 is a 1H period while the polarity of the driving voltage of the data signal Dm is not reversed. In the first preferred embodiment, the times T2, T4 and T6 are times for the source driver 25 to change the output of the data signal Dm, and in display of the raster screen, since the polarity of the data signal Dm is not changed at the time T4, there is no change in waveform as shown in FIG. 2.

Further, in FIG. 2, the first gate selection signal Gn indicates a timing of the gate selection signal to be supplied to the gate wire 22 of the n-th line and is turned on at the time T1 and turned off at the time T3. The polarity of the data signal Dm is reversed at the time T2 in a period while the first gate selection signal Gn is ON. The second gate selection signal Gn+1 indicates a timing of the gate selection signal to be supplied to the gate wire 23 of the (n+1)-th line and is turned on at the time T3 and turned off at the time T5. At the time T4 in a period while the second gate selection signal Gn+1 is ON, the data signal Dm is changed to a corresponding data signal Dm to be outputted and the polarity thereof is not reversed. The period Tn of FIG. 2 is a period while the data signal Dm to be written into the pixel electrode 13 positioned on the line of the n-th gate wire 22 has the positive polarity, which corresponds to the period T2-T4. Similarly, the period Tn+1 is a period while the data signal Dm to be written into the pixel electrode 26 positioned on the line of the (n+1)-th gate wire 23 has the positive polarity, which corresponds to the period T4-T6. It is assumed that the period Wn from the time T2 when the polarity of the data signal Dm is reversed to the time T3 when the first gate selection signal Gn is turned off is the first period and the period Wn+1 from the time T3 when the second gate selection signal Gn+1 is turned on to the time T5 when it is turned off is the second period.

In the first preferred embodiment, in order to ensure a sufficient period for charging the pixel electrodes, the time when the gate selection signal Gn is turned off and the time when the gate selection signal Gn+1 is turned on are synchronized at the time T3. In other words, no horizontal blanking period is provided and the selection period for each line is changed to the next selection period for the next line immediately with no time passing. Further, in order to prevent wrong writing due to the delay of turn-off caused by the dullness in waveform of the gate selection signal as indicated by broken line in FIG. 2, the gate selection signal Gn+1 of the preceding line is turned off earlier by the third period between the time T6 when the polarity of the data signal Dm is changed and the time T5 when the gate selection signal Gn+1 of the preceding line is turned off, to compensate the delay of turn-off.

In FIG. 2, assuming that the third period is τ, the period T1-T2 and the period T5-T6 correspond to the third period τ. In other words, the not-shown gate selection signal Gn−1 of the gate wire 21 of the (n−1)-th line is turned off at the time T1 which is earlier than the time T2 when the polarity of the data signal Dm is changed, by the period τ and at the same time T1, the gate selection signal Gn is turn on. Further, the gate selection signal Gn+1 of the gate wire 23 of the (n+1)-th line is turned off at the time T5 which is earlier than the time T6 by the third period τ and at the same time, the gate selection signal Gn+2 is turn on. The third period τ is set at a predetermined value in consideration of the delay of the gate selection signal.

The period Wn is the first period while the gate selection signal Gn selects the data signal which has the same polarity as the data signal Dm to be written into the pixel electrode has, and the period Wn+1 is the second period while the gate selection signal Gn+1 selects the data signal which has the same polarity as the data signal Dm to be written into the pixel electrode has. In the first preferred embodiment, assuming that all the gate wires have the same horizontal synchronizing period and the period is H, it is set that Tn=Tn+1=H.

In the first preferred embodiment, as discussed earlier, the time when the gate selection signal Gn is turned off and the time when the gate selection signal Gn+1 is turned on are synchronized at the time T3, with no horizontal blanking period passing therebetween, and the time T3 is set so that the first period Wn and the second period Wn+1 should be equal to each other.

Next, discussion will be made on the relation between the time T3 and the time T4 for changing the output, from the data signal Dm corresponding to the gate selection signal Gn to the data signal Dm corresponding to the gate selection signal Gn+1. As shown in FIG. 2, in the first preferred embodiment, the time T4 for changing of the output of data signal Dm is the central point of the period T2-T6 and the period T3-T4 which is the fourth period is half the period τ. In other words, the time T4 is so set as to be delayed from the time T3 when the first gate selection signal Gn is turned off, by half the third period from the time T5 when the second gate selection signal Gn+1 is turned off to the time T6 when the polarity of the data signal Dm is changed. Since the voltage of the data signal Dm is not changed after the gate selection signal Gn is turned off, this delay produces no influence on the display.

Thus, in the first preferred embodiment, the period Wn while the data signal is written into the pixel electrode connected to the gate wire in which the polarity of the data signal is reversed is equal to the period Wn+1 while the data signal is written into the pixel electrode connected to the gate wire in which the polarity of the data signal is not reversed and it is therefore possible to suppress a lateral stripe moire in display of the raster screen or the like. Further, since the writing periods Wn and Wn+1 to the pixel electrodes are each a period (H−τ/2) regardless of whether the polarity of the data signal is reversed or not, it is possible to ensure a writing period to the pixel electrode which is longer than the conventional writing period (H−τ) to the pixel electrode by τ/2 and therefore possible to achieve high contrast characteristics even in a high-resolution liquid crystal display.

### The Second Preferred Embodiment

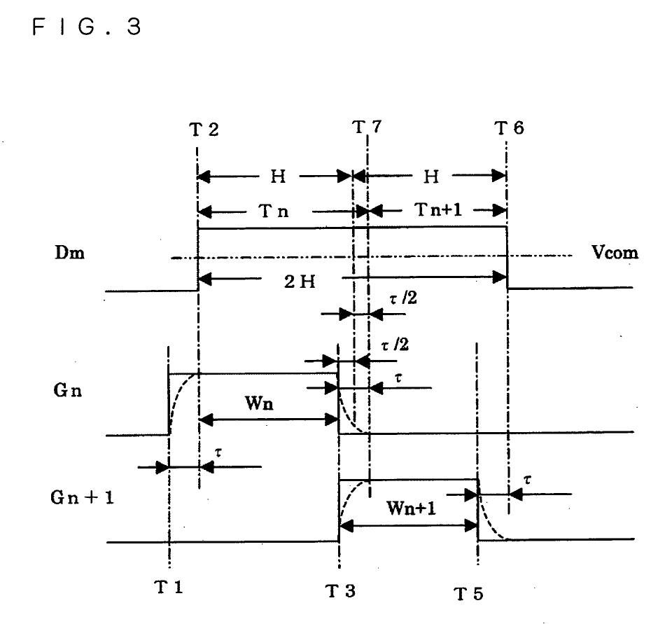

FIG. 3 is a timing chart showing a driving method for a liquid crystal display in accordance with the second preferred embodiment of the present invention. In the second preferred embodiment, the time T4 for changing the output of the data signal Dm shown in FIG. 2 of the first preferred embodiment is delayed by the period τ/2, to be the time T7, and the fourth period, i.e., the period T3-T7, is τ. In other words, the period T5-T6 which is the third period and the period T3-T7 which is the fourth period have the same length τ. Others are the same as those in the first preferred embodiment and will not be discussed.

As shown in FIG. 3, a signal output period of the data signal Dm is Tn=H+τ/2, Tn+1=H−τ/2. In the second preferred embodiment, since the time T7 for changing the output of the data signal Dm is so set as to be delayed from the time T3 when the gate selection signal Gn is turned off, by the fourth period τ minutes, for all the gate wires, it is possible to suppress unevenness of display caused by the dullness in gate wire even in display other than that of the raster screen. Further, a period between the time T2 and the time T6 is twice the 1H period, like in the first preferred embodiment.

Further, like in the first preferred embodiment, the first period Wn is equal to the second period Wn+1, and it is therefore possible to suppress a lateral stripe moire in display of the raster screen or the like. Both in the first period Wn and the second period Wn+1, the writing period to the pixel electrode in display of the raster screen is a period (H−τ/2), and it is therefore possible to ensure a writing period to the pixel electrode which is longer than the conventional writing period (H−τ) to the pixel electrode by τ/2 and possible to achieve high contrast characteristics even in a high-resolution liquid crystal display.

Though the time T4 or the time T7 for changing the output of the data signal is set so that the fourth period should be a period τ/2 or a period τ in the first or second preferred embodiment, the fourth period may be shorter only if it should be equal to or shorter than the third period, i.e., the period τ and no particular problem in display arises, and there may be a case, for example, where the time T4 for changing the output of the data signal is manually adjusted by observing the displayed screens.

In the first and second preferred embodiments, discussion has been made on, as an example, the driving method for an active matrix-type liquid crystal panel using a general-type TN (Twisted Nematic) liquid crystal as a pixel structure. Therefore, the discussion has been made on the case where the electrode potential of the opposed substrate is Vcom potential but the driving methods in the first and second preferred embodiments can be applied to a liquid crystal panel adopting a normally black liquid crystal mode, typified by the IPS (In Plane Switching) driving method where a counter electrode is placed on the same plane as the pixel electrode is placed on and the VA (Vertical Alignment) driving method adopting a vertical alignment. In this case, since it is possible to ensure a sufficient writing period to the pixel electrode even for a high-resolution liquid crystal display, high white luminance and a well-balanced full white screen display can be achieved.

Though a method for alternating the liquid crystal driving voltage is not particularly shown in the first and second preferred embodiments, the driving method in the first and second preferred embodiments can be applied to a 2H dot reverse driving method and a 2H line reverse driving method in which the 2H reverse driving method is applied to the conventionally-adopted dot reverse driving method and line reverse driving method, and it is thereby possible to provide a liquid crystal display with low power consumption.

Though discussion has been made on the first and second preferred embodiments taking the 2H reverse driving method as an example, the present invention can be also applied to a plural horizontal synchronizing period reverse driving method, such as a 3H reverse driving method, like in the background art. In this case, in order to set a data signal selection period having the same length as the period Wn or Wn+1 also in the 3H line and the following while keeping a certain horizontal synchronizing period, a blanking period has only to be provided in the 3H line and the following.

The liquid crystal display of the present invention which is driven by using the driving method of the first or second preferred embodiment has a construction shown in FIG. 1 and comprises the gate driver 20 for supplying the gate selection signals to the gate wires 21, 22 and 23, the source driver for supplying the data signals to the source wires 16, 17, 18 and 19, and the control circuit 24 for controlling the gate driver 20 and the source driver 25 by the driving method of the first or second preferred embodiment.

In accordance with such a construction of the present invention, it is possible to avoid a lateral stripe moire in display of the raster screen or the like and provide a liquid crystal display with high resolution and high contrast.

While the invention has been shown and described in detail, the foregoing description is in all aspects illustrative and not restrictive. It is therefore understood that numerous modifications and variations can be devised without departing from the scope of the invention.

What is claimed is:

1. A method of driving a liquid crystal display, in which
a plurality of switching devices connected to a plurality of pixel electrodes surrounded by a plurality of gate wires and a plurality of source wires are controlled on conduction by a selection signal supplied through said gate wires, and
through said switching devices, a data signal supplied through said source wires is supplied to said pixel electrodes,
wherein it is controlled that the polarity of said data signal is reversed in an ON period of a first gate selection signal and said polarity of said data signal is not reversed in an ON period of a second gate selection signal,
a first period from the time when said polarity of said data signal is reversed to the time when said first gate selection signal is turned off is equal to a second period from the time when said second gate selection signal is turned on to the time when said second gate selection signal is turned off, and
a fourth period from the time when said first gate selection signal is turned off to the time when said data signal is applied as corresponding data output to one of said pixel electrodes which is selected by said second gate selection signal is not longer than a third period from the time when said second gate selection signal is turned off to the time when said polarity of said data signal is reversed.

2. The method according to claim 1, wherein
the time when said first gate selection signal is turned off and the time when said second gate selection signal is turned on are synchronized to each other.

3. The method according to claim 1, wherein
said fourth period is made half of said third period.

4. The method according to claim 2, wherein
said fourth period is made half of said third period.

5. The method according to claim 1, wherein
said fourth period is equal to said third period.

6. The method according to claim 2, wherein
said fourth period is equal to said third period.

7. A liquid crystal display comprising:
a gate driver for supplying a gate selection signal to a gate wire;
a source driver for supplying a data signal to a source wire; and
a control circuit for controlling said gate driver and said source driver by said driving method as defined in claim 1.

8. A liquid crystal display comprising:
a gate driver for supplying a gate selection signal to a gate wire;
a source driver for supplying a data signal to a source wire; and
a control circuit for controlling said gate driver and said source driver by said driving method as defined in claim 2.
